(19) United States
(12) Patent Application Publication
(10) Pub. No.: US 2026/0150149 A1
(43) Pub. Date: May 28, 2026

(54) USER PLANE PROCESSING AND DATA FORWARDING

(71) Applicant: ZTE Corporation, Shenzhen (CN)

(72) Inventors: Li YANG, Shenzhen (CN); Fenghe HUANG, Shenzhen (CN); Yan XUE, Shenzhen (CN); Feng XIE, Shenzhen (CN)

(73) Assignee: ZTE Corporation, Shenzhen (CN)

(21) Appl. No.: 19/362,090

(22) Filed: Oct. 17, 2025

Related U.S. Application Data
(63) Continuation of application No. PCT/CN2023/100860, filed on Jun. 16, 2023.

(51) Int. Cl. H04W 76/20; H04W 28/06; H04W 80/06

(52) U.S. Cl. CPC H04W 76/20; H04W 28/065; H04W 80/06

(57) ABSTRACT

An extension of user plane (UP) processing and data forwarding functions include support for additional services. Rather than just communication, a configuration of UP functions may include support for services that include computing services, intelligence services, storage services, or security services.

### TECHNICAL FIELD

This document is directed generally to wireless communications. More specifically, user plane (UP) processing and data forwarding functions include support for additional services.

### BACKGROUND

Wireless communication technologies are moving the world toward an increasingly connected and networked society. Wireless communications rely on efficient network resource management and allocation between user mobile stations and wireless access network nodes (including but not limited to radio access network (“RAN”) nodes and wireless basestations). A new generation network is expected to provide high speed, low latency and ultra-reliable communication capabilities and fulfil the requirements from different industries and users. User mobile stations or user equipment (“UE”) are becoming more complex and the amount of data communicated continually increases. With the development of more advanced radar and sensing systems, communications between with the UE can be modernized.

### SUMMARY

This document relates to methods, systems, and devices for an extension of user plane (UP) processing and data forwarding functions include support for additional services. Rather than just end to end (E2E) communication service, a configuration of UP functions may include support for services that include communication service, computing services, intelligence services, storage services, or security services, etc.

In one embodiment, a method for wireless communication includes configuring a network entity for user plane (UP) functions; and receiving the configuration. The UP functions comprise identifying the service type, UP processing, and UP data forwarding. The UP functions support services in addition to a communication service, including at least computing, intelligence, storage, and/or security services. The network entity comprises a user plane (UP) entity. The configuring is by a control plane (CP) entity for the UP entity and wherein the configuration is received at the UP entity from the CP entity. The configuring is through internal signaling or interface based signaling. The configuring comprises a configuration of one or more user plane (UP) entities. The configuring comprises configuration of a service type, UP processing mode, or UP forwarding mode. The service type, the UP processing mode, or the UP forwarding mode comprises an index identification or explicit indication that are predefined. The configuration is configured for allowing a data transfer service to terminate at an intermediate node rather than an end node. The intermediate node is configured to forward user data of different service types to any other network node. The configuring comprises configuration of processing modes, wherein the processing modes at least comprise: transparently deliver incoming packet; compressing incoming packet; concatenating incoming packets; segmenting incoming packets; or locally backup packets. The configuring comprises configuration of forwarding modes, wherein the forwarding modes at least comprise: PDU session type; DRB type; control plane (CP) signaling type; TCP type; or QUIC type.

In another embodiment, a method for wireless configuration the method includes establishing a user plane (UP) configuration for a network entity for supporting different types of services; and performing UP processing based on receipt of the UP configuration. Services supported comprise communication services, computing services, intelligence services, storage services, or security services. The network entity comprises a user plane (UP) entity for performing behaviors according to UP configuration, wherein the establishing and configuring are by a control plane (CP) entity. UP configuration comprises a configuration of one or more user plane (UP) entities. The establishing is through internal signaling or interface based signaling. The UP configuration is for a service type, UP processing mode, or UP forwarding mode. The service type, the UP processing mode, or the UP forwarding mode comprises an index identification or explicit indication that are predefined. The UP configuration allows a data transfer service to terminate at an intermediate node rather than an end node. The intermediate node is configured to forward user data of different service types to any other network node. The UP configuration is for processing modes, wherein the processing modes at least comprise: transparently deliver incoming packet; compressing incoming packet; concatenating incoming packets; segmenting incoming packets; or locally backup packets. The UP configuration is for forwarding modes, wherein the forwarding modes at least comprise: PDU session type; DRB type; control plane (CP) signaling type; TCP type; or QUIC type.

In another embodiment, a wireless communications apparatus includes a processor and a memory, wherein the processor is configured to read code from the memory and implement any method recited herein.

In another embodiment, a computer program product includes a computer-readable program medium code stored thereupon, the code, when executed by a processor, causing the processor to implement any method recited herein.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a single connectivity wireless communication system.

FIG. 4 shows a split case single connectivity wireless communication system.

FIG. 5 shows an embodiment of a wireless network system architecture.

FIG. 6 shows user plane (UP) processing and data forwarding.

FIG. 7 shows a single basestation system diagram with extended user plane (UP) processing and data forwarding.

FIG. 8 shows a dual basestation system diagram with extended user plane (UP) processing and data forwarding.

FIG. 9 shows protocol stacks for different user plane (UP) processing forwarding modes.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

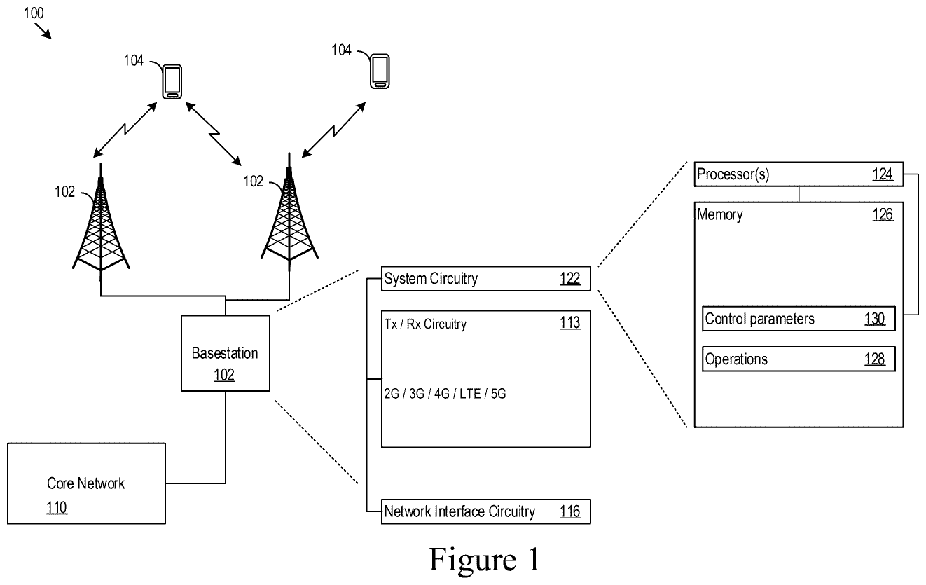

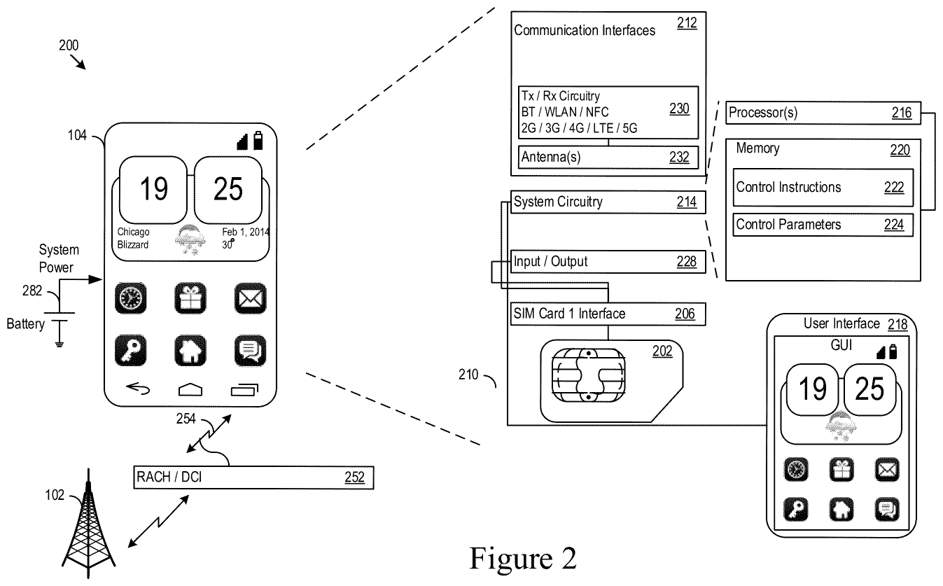

Radio resource control (“RRC”) is a protocol layer between UE and the basestation at the IP level (Radio Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). UE can transmit infrequent (periodic and/or non-periodic) data in RRC_INACTIVE state without moving to an RRC_CONECTED state. This can save the UE power consumption and signaling overhead. This can be through a Random Access Channel (“RACH”) protocol scheme or a Configured Grant (“CG”) scheme. The wireless communications described herein may be through radio access. FIGS. 1-2 show example radio access network (“RAN”) nodes (e.g. basestations) and user equipment and messaging environments, which may be applicable the user plane (UP) functions and communications described below.

With the latest development of wireless communication systems (e.g. 5G-NR and 6G wireless systems) along with various distributed computing, intelligence, storage, and security systems, integration may be a challenge. Integration with each other may be in terms of architecture or capability, or network and air interface resource usages, etc. The 5G-Advanced (5G-A) and 6G wireless systems may attempt to integrate various new functions and services with legacy systems, including but not limited to computing services, intelligence services, storage services, and/or security systems. As a result, core network (CN) and RAN nodes may not only provide wireless communication service, but also provide computing services, intelligence services, storage services, and/or security services, etc.

User Plane (UP) processing and data forwarding functions may be used for processing and transferring user data associated to different users' mobile services, such as mobile APP and Web services. As result, UP processing and data forwarding functions in a network node may not be concerned about the data type/content or characteristics of user data. Rather it may process and forward them from input port to output port based on the internal UP processing unit. As described below, additional service types of data may be processed and transferred based on an extension of the functions of the UP processing and data forwarding. This extension may cover different service types. The wireless network node can distinguish different types of service data and to adopt different UP tackling and processing strategies for different types of service data processing and forwarding, so that the goal of network interface resource efficiency can be achieved.

FIG. 1 shows an example (“RAN”) node or basestation 102. The RAN node may also be referred to as a wireless network node. The RAN node 102 may be further identified to as a nodeB (NB, e.g., an eNB or gNB) in a mobile telecommunications context. The example RAN node may include radio Tx/Rx circuitry 113 to receive and transmit with user equipment (UEs) 104. The RAN node may also include network interface circuitry 116 to couple the RAN node to the core network 110, e.g., optical or wireline interconnects, Ethernet, and/or other data transmission mediums/protocols.

The RAN node may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the RAN node. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a RAN node 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

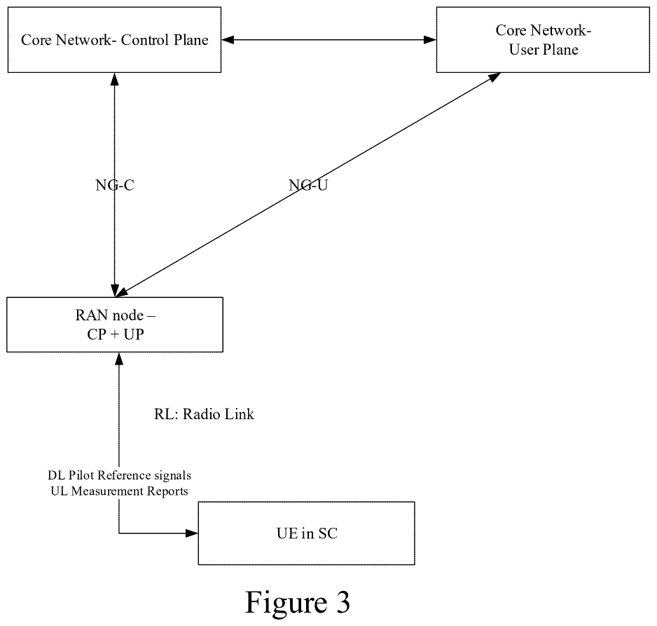

FIG. 3 shows a single connectivity wireless communication system. Single connectivity (SC) may include a UE that only has a master radio link (M-RL) but no radio links on the secondary RAN node side. Conversely, dual connectivity (DC) includes a UE with a secondary communication radio link (S-RL) on the secondary RAN node side. In IMT wireless communication systems (such as 4G-LTE and 5G-NR) as shown in FIG. 3, the Radio Access Network (RAN) node may transmit downlink (DL) pilot reference signals such as SSB, CSI-RS, etc. The UE receives, measures and processes them so that UE can know the connection quality of radio link (RL) over the air. This may be the communications between the serving RAN node and UE, in order to maintain the communication service continuity. This is an example with single connectivity (SC).

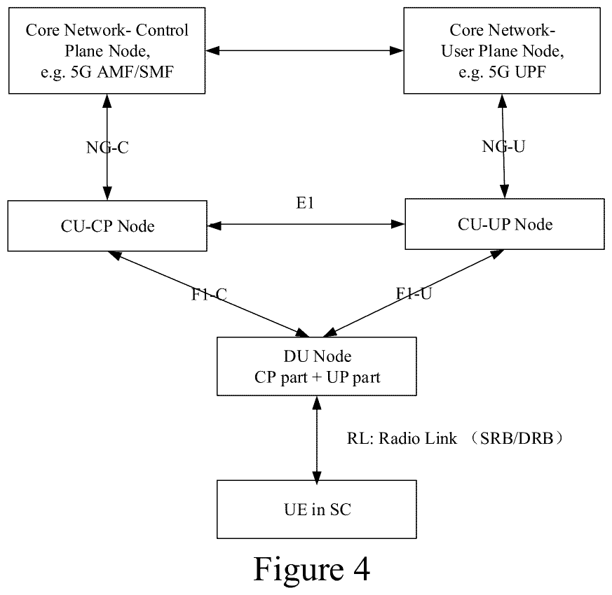

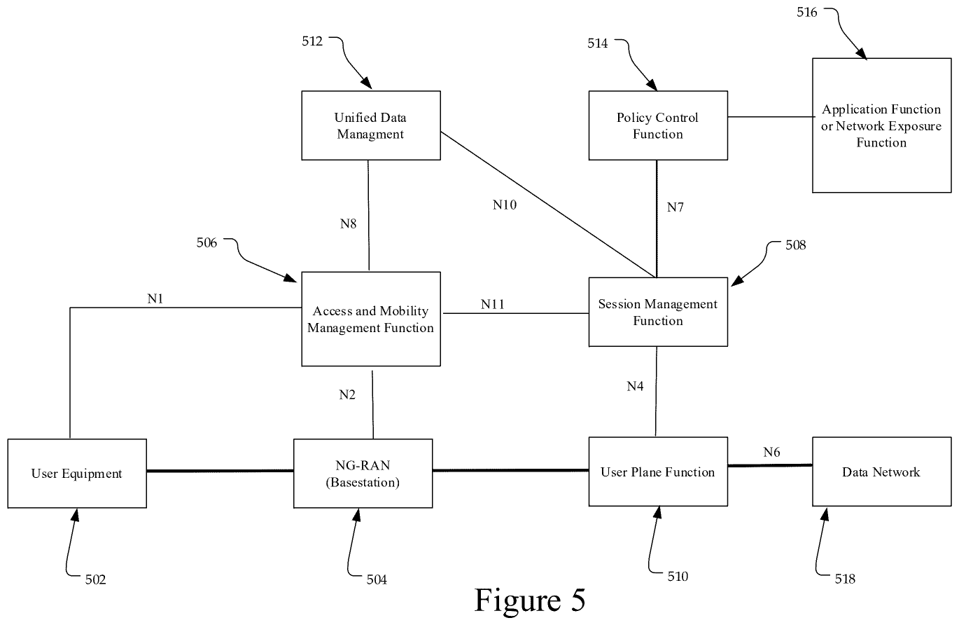

FIG. 4 shows a split case single connectivity wireless communication system. FIG. 3 shows a non-split case, while FIG. 4 illustrates a split of CU-CP node and CU-UP node. In IMT wireless communication systems (such as 5G-NR specified by 3GPP) as shown in FIGS. 3-4, the Core Network (CN) may include various types of control plane (CP) nodes or entities (e.g. 5G AMF/SMF), and a user plane (UP) node or entity (e.g. 5G UPF). In the RAN non-split case in FIG. 3, the RAN node (e.g. 5G aggregated basestation) includes a CP part and UP part, and then terminates on UE via a radio link (RL) in the air. In the RAN split case of FIG. 4, the RAN node (e.g. 5G dis-aggregated basestation) includes a CU-CP node, CU-UP node, and DU node or entities, and then terminates on UE via RL in the air. The CP part or node may be responsible for generating, processing, and transferring control signaling (e.g. for (re) configuring and monitoring other nodes). The UP part or node is responsible for processing and transferring user data (e.g. associated to mobile APP and Web services, etc.). For both the CP and UP plane, there may be a separate interface and protocol stack and normally spans from CN domain to RAN network and then to UE. The UP functions are further described below and can be implemented in the systems shown in FIGS. 1-2 or in the system of FIG. 5 described below.

FIG. 5 shows an embodiment of a wireless network system architecture. This architecture is merely one example and there may be more or fewer components for implementing the embodiments described herein. The interconnections or communications between components are identified as N1, N2, N4, N6, N7, N8, N10, and N11, which may be referred to in the description or by other Figures. FIG. 2 illustrated an example user equipment (“UE”) 104. UE 502 is a device accessing a wireless network (e.g. 5GS) and obtaining service via a NG-RAN node or basestation 504. The UE 502 interacts with an Access and Mobility Control Function (“AMF”) 506 of the core network via NAS signaling. FIG. 1 illustrates an example basestation or NG-RAN 102. The NG-RAN node 504 is responsible for the air interface resource scheduling and air interface connection management of the network to which the UE accesses. The AMF 506 includes the following functionalities: Registration management, Connection management, Reachability management and Mobility Management. The AMF 506 also perform the access authentication and access authorization. The AMF 506 is the NAS security termination and relay the session management NAS between the UE 502 and the SMF 508, etc.

The SMF 508 includes the following functionalities: Session Management e.g. Session establishment, modify and release, UE IP address allocation & management (including optional Authorization), Selection and control of uplink function, downlink data notification, etc. The user plane function (“UPF”) 510 includes the following functionalities: Anchor point for Intra-/Inter-RAT mobility, Packet routing & forwarding, Traffic usage reporting, QoS handling for user plane, downlink packet buffering and downlink data notification triggering, etc. The Unified Data Management (“UDM”) 512 manages the subscription profile for the UEs. The subscription includes the data used for mobility management (e.g. restricted area), session management (e.g. QoS profile). The subscription data also includes slice selection parameters, which are used for AMF 506 to select a proper SMF 508. The AMF 506 and SMF 508 get the subscription from the UDM 512. The subscription data may be stored in a Unified Data Repository with the UDM 512, which uses such data upon reception of request from AMF 506 or SMF 508. The Policy Control Function (“PCF”) 514 includes the following functionality: supporting unified policy framework to govern network behavior, providing policy rules to control plane function(s) to enforce the policy rule, and implementing a front end to access subscription information relevant for policy decisions in the User Data Repository. The Network Exposure Function (“NEF”) 516 is deployed optionally for exchanging information with an external third party. In one embodiment, an Application Function (“AF”) 516 may store the application information in the Unified Data Repository via NEF. The UPF 510 communicates with the data network 518.

Access Mobility Function (“AMF”) and Session Management Function (“SMF”) are the control plane entities and User Plane Function (“UPF”) is the user plane entity in new radio (“NR”) or 5GC. The signaling connection between AMF/SMF and MN may be a Next Generation-Control Plane (“NG-C”)/MN interface. The signaling connection between MN and SN may be an Xn-Control Plane (“Xn-C”) interface. The signaling connection between MN and UE may be a Uu-Control Plane (“Uu-C”) RRC interface. As described below, there may be additional components or entities for UP processing and data forwarding functions.

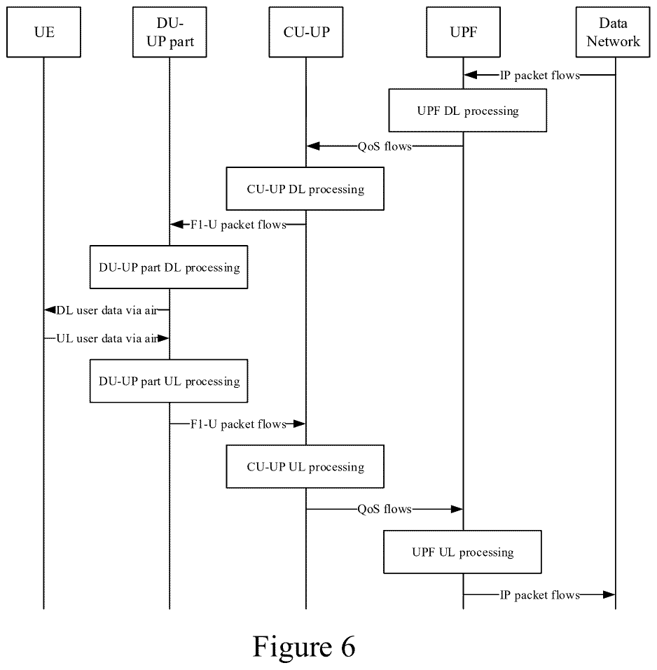

FIG. 6 shows user plane (UP) processing and data forwarding in one example. For either UP part integrated in the network node or the UP node as a separate network node, it may be (re) configured by the CP part or CP node, with UP processing strategies and various protocol parameters. Once the UP part or UP node obtains the input user data (i.e. DL/UL packet flows), it processes them accordingly based on CP configurations, and then outputs/forwards them to the next UP part or UP node in sequence. Without the additional functions, in the legacy wireless communication systems (such as 4G-LTE and 5G-NR), the user data may be always terminated on either particular UE in DL direction or data network server in UL direction, so it is always an end to end (E2E) communication service that serves for only transferring user data. The mechanism for UP processing and data forwarding is shown in FIG. 6. In the embodiments below, there are additional functions/services for the UP processing and data forwarding.

In some embodiments, the UP functions (e.g. UP and data forwarding) are used for various services rather than just E2E communication service as had been the default. Likewise, the services are more than transferring user data of UE (i.e. UE associated) at the end nodes. Rather, the transferring of user data can now be terminated on any intermediate network node in addition to the UE or data network/DN server.

In some embodiments, the intermediate network node or entity (e.g. 5G UPF, CU-UP and DU-UP part) can both trigger and initiate the UP functions by itself. This may occur without requiring input user data from an upstream or downstream node. For the data generated by intermediate network node, its transferring may be based on current UP function or tunnels.

In some embodiments, the intermediate network node may dynamically process and then forward the user data to upstream or downstream target nodes. The target may not be static based on association with the served UE. The intermediate network node can forward the user data to any other network node, even those not associated to the served UE. This may be referred to as the “UP transferring path” and is able to be dynamic or adjusted rather than static/fixed.

In some embodiments, for any UP entity, the UP processing mode, forwarding mode and their related interface protocol stacks may be used for different services rather than being required only for forwarding any user data of any UE, regardless of different traffic characteristics.

### Services

As mentioned, the extended/expanded services in addition to E2E communication may include computing services, intelligence services, storage services, and/or security services, etc. These services' capabilities may be integrated into the wireless communication systems. Various data of different service types may be processed and forwarded during their distributed service operations. The traffic characteristics with these services may flow different from the legacy E2E communication service. Example differences include data generator and packet size/frequency/period, etc. As described in the embodiments herein, there may changes to the UP mechanism to incorporate the additional services/functions. This may be referred to as an extension or extended UP processing and data forwarding functions.

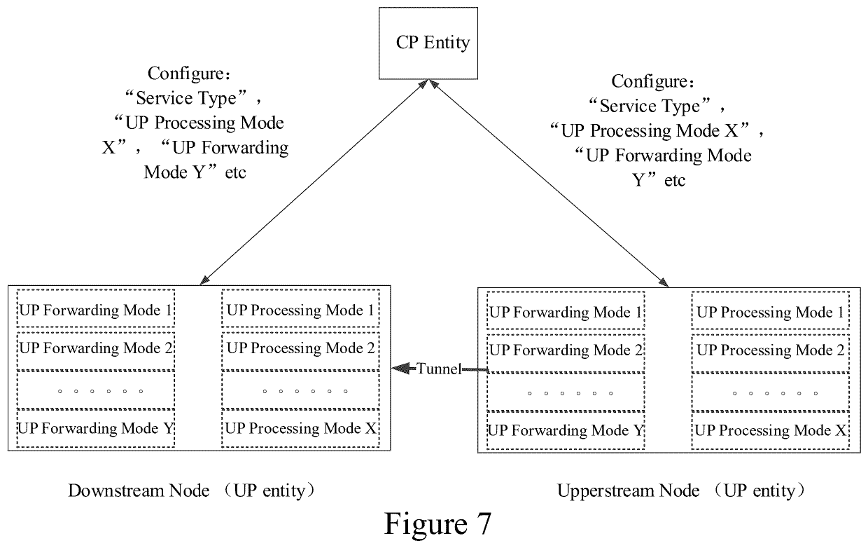

FIG. 7 shows a single basestation system diagram with extended user plane (UP) processing and data forwarding. This diagram is a centralized model for extending usage of the UP processing and data forwarding functions. The single basestation has a single CP entity in one embodiment. While the CP entity and UP entity are shown separately, they may be together physically. There may be several blocks in UP entity including forwarding modes and processing modes. Legacy UP entity (only for communication) does not have so many modes as we have here. The CP entity may configure proper UP processing mode and/or UP forwarding mode. The extension of the function of the UP entity includes providing additional services (in addition to communication).

The following are relevant terms for the extension other UP functions:
“CP entity”: refers to control plane (CP) part integrated in certain network node or dedicated CP node as a separate network node.
“UP entity”: refers to user plane (UP) part integrated in certain network node or dedicated UP node as separate network node.
“UP functions”: refers to the user plane (UP) packet processing, data forwarding and the related UP interface protocol stack.
“Communication Service Data”: user data generated by either data network server or UE, associated to certain E2E communication services.
“Computing Service Data”: intermediate data generated by any network node, associated to certain computing services.
“Intelligence Service Data”: intermediate data generated by any network node, associated to certain Intelligence services.
“Storage Service Data”: intermediate data generated by any network node, associated to certain storage services.
“Security Service Data”: intermediate data generated by any network node, associated to certain security services.
“Multiple Service Node”: network node capable of multiple types of services other than the legacy E2E communication service alone.
“Service Type”: at least refers to additional services, including but not limited to: communication, computing, Intelligence, storage, and security services supported by the network.
“UP Processing Mode”: the mode by which the “UP entity” processes the input data of a certain service type.
“UP Forwarding Mode”: the mode by which the “UP entity” forwards the output data of a certain service type.
“UP Configuration”: the setting and configurations of “Service Type”, “UP Processing Mode”, “UP Forwarding Mode” and other UP function related parameters.

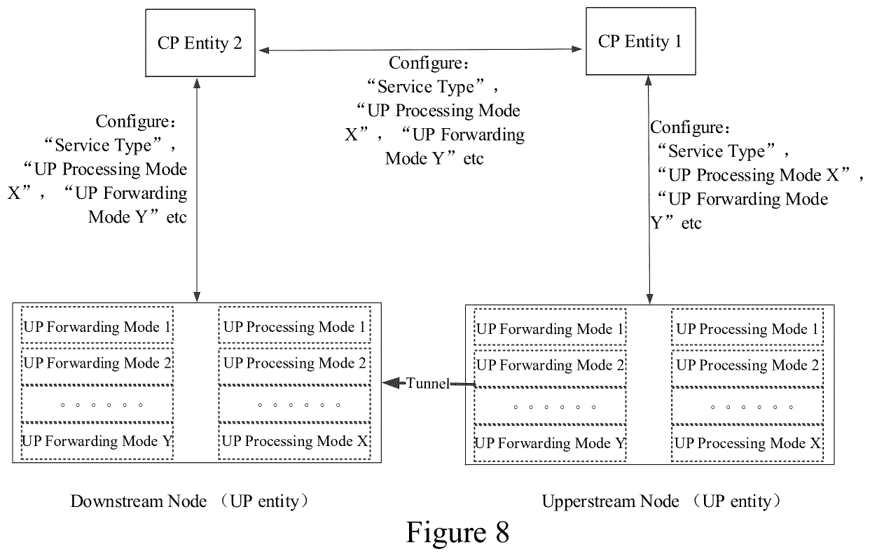

FIG. 8 shows a dual basestation system diagram with extended user plane (UP) processing and data forwarding. As with FIG. 7, the diagram is a decentralized model for extending usage of UP processing and data forwarding functions. As shown, there may be two separate basestations, each with one CP entity. In this example, there may be Xn signaling between CP entities. For the split basestation, the CP entity and UP entity may be physically separate.

Referring to either FIG. 7 or FIG. 8, the following are features of the extension of UP functions. The CP entity may configure one or more UP entities with parameters such as “Service Type”, “UP Processing Mode” and “UP Forwarding Mode” via internal signaling or interface based signaling. The contents of parameters: “Service Type”, “UP Processing Mode” and “UP Forwarding Mode” may take the form of an index identification or explicit indication. The meaning of each index id or indications may be predefined by normative specifications. The “UP Configuration” configured by the CP entity may be adapted to different types of services, such as the communication, computing, Intelligence, storage, and/or security services described herein. To decouple with legacy existing parameters similar to “Service Type”, “UP Processing Mode” and “UP Forwarding Mode” there may be new parameters, including but not limited to: “New Service Type”, “New UP Processing Mode” and “New UP Forwarding Mode” which may be additionally defined and used instead.

The two neighbor CP entities may synchronize the contents of “Service Type”, “UP Processing Mode” and “UP Forwarding Mode” etc. via interface based signaling, so that the UP handling in the neighbor UP entities can be synchronized or adapted to each other.

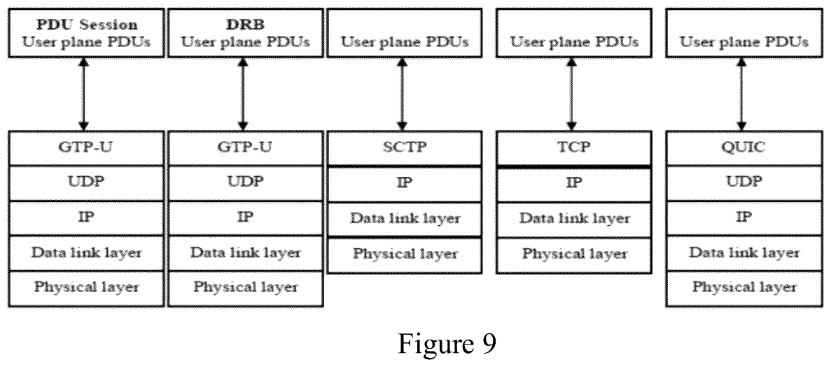

The “Multiple Service Node” is capable of supporting multiple services, such as the communication, computing, Intelligence, storage, and/or security services described herein, and is capable of supporting one or multiple “UP Processing Modes” and “UP Forwarding Modes” as well as multiple related interface protocol stacks described below with respect to FIG. 9.

The “UP Processing Modes” may include at least: “transparently deliver incoming packet”, “compressing incoming packet”, “concatenating incoming packets”, “segmenting incoming packets”, and/or “locally backup packets,” etc. The “UP Forwarding Modes” may include at least: “PDU Session type”, “DRB type”, “CP Signaling type”, “TCP type”, “QUIC type”, etc. Further, their related interface protocol stacks are shown in FIG. 9.

FIG. 9 shows protocol stacks for different user plane (UP) forwarding modes. As shown are examples of different “UP Forwarding Modes” and corresponding protocol stacks. These protocols are merely examples that can be used for various services. NG uses PDU session. QUIC may be a combination of TCP and PDU. New UP functions may support at least these protocol stacks, but there may be additional protocol stacks that are to be supported in future. As described, the protocol stack that is supported can be configured as part of the extension of UP functions. This configuration allows for support of various protocol stacks.

Upon the configuration by the controlling CP entity, the UP entity in Multiple Service Node performs the corresponding UP processing and UP data forwarding activities as configured. The two neighbor UP entities can exchange different types of service data via different types of UP Forwarding Modes or related UP interface protocol stacks, based on different types of data transferring tunnels configured by the CP entity.

As described and shown in FIGS. 7-8, the configuration may include the Service Type, UP Processing Mode, and/or the UP Forwarding Mode. Because of the configurability provided, any of those types/modes can be varied. Further, the tunnel type between CU-UP's and the signaling procedure with the CP (and between CPs for FIG. 8) can also be varied. When multiple services are configured simultaneously, different types of tunnels can be established and co-exist between the same concerned CU-UP's. and any combination is possible for these configurable parameters. Below are example embodiments that describe particular combinations of those configurable parameters. These are merely examples and many other combinations are possible in other examples.

In a first embodiment as in FIG. 7, the CU entity communicates via the E1AP signaling procedure. The tunnel type is PDU session. For this example, the Service Type is computing service, deep packet inspecting (DPI) operation, the UP Processing Mode is compressing incoming packets, and the UP Forwarding Mode is PDU Session Type. This is merely one example of the parameters that can configured.

The UP entities are capable of performing certain kind of computing task, e.g. executing particular DPI algorithm towards the incoming packets. Due to lack of computing power resources locally or in order to obtain better DPI analyzing results, the CP entity may let the upstream UP entity and downstream UP entity perform the computing task jointly, e.g. upstream UP entity performs DPI operation towards some of the “odd number” QoS Flow packets, and downstream UP entity performs DPI operation towards some of the “even number” QoS Flow packets in one example. The Computing Service Data is transferred from upstream UP entity to downstream UP entity via a type of forwarding tunnel.

As controlling node, CP entity configures the upstream UP entity and downstream UP entity individually via E1AP signaling procedure, which includes the following parameters:
“Service Type”: computing service, DPI operation,
“UP Processing Mode”: compressing incoming packets, and
“UP Forwarding Mode”: PDU Session Type.

Upon configuration by the CP entity, the upstream UP entity performs a computing task as indicated (e.g. DPI operation), and it shall compress the incoming QOS Flow packets as indicated. Further, it may transfer some of the “Computing Service Data” (e.g. user data packet) towards the neighbor downstream UP entity for offloading the computing task. Likewise, downstream UP entity gets to know that it shall perform a kind of computing task as indicated (e.g. DPI operation), and it may compress the incoming QOS Flow packets as indicated, and receive some of the “Computing Service Data” from the neighbor upstream UP entity. Upon configuration by the CP entity, the upstream UP entity may establish the “PDU Session Type Tunnel” with the neighbor downstream UP entity. Afterwards, upstream UP entity and downstream UP entity individually perform the computing task as indicated (e.g. DPI operation), and the “Computing Service Data” is transferred via the established “PDU Session Type Tunnel” and further processed by downstream UP entity.

In a second embodiment, there may be multiple CU entities as in FIG. 8. This is different from embodiment 1 because of the multiple CU entities and because the tunnel type and the forwarding mode is DRB. The CU entities communicate via an Xn interface. For this example, the Service Type is computing service, deep packet inspecting (DPI) operation, the UP Processing Mode is compressing incoming packets, and the UP Forwarding Mode is DRB Type. This is merely one example of the parameters that can configured.

One CP entity is connecting with the upstream UP entity, and the other CP entity is connecting with the downstream UP entity via standardized E1 interface. The neighbor upstream UP entity and downstream UP entity are both capable of performing certain kind of computing task (e.g. executing particular DPI algorithm) towards the incoming packets. Due to a lack of computing power resources locally or in order to obtain better DPI analyzing results, one CP entity decides to let upstream UP entity and the downstream UP entity connected to the other CP entity perform the computing task jointly. In one example, upstream UP entity performs DPI operation towards some of the “odd number” QoS Flow packets and downstream UP entity performs DPI operation towards some of the “even number” QoS Flow packets. The “Computing Service Data” may be transferred from upstream UP entity to downstream UP entity via a proper type of forwarding tunnel.

As controlling node, the first CP entity configures the upstream UP entity via E1AP signaling procedure, which includes the following parameters in this example:
“Service Type”: computing service, DPI operation,
“UP Processing Mode”: compressing incoming packets,
“UP Forwarding Mode “: DRB Type.

The first CP entity transmits the configuration parameters to the other CP entity via Xn signaling procedure, then the second/other CP entity configures the downstream UP entity via E1AP signaling procedure, which include the following parameters in this example:
“Service Type”: computing service, DPI operation,
“UP Processing Mode”: compressing incoming packets,
“UP Forwarding Mode”: DRB Type.

Upon configuration by the first CP entity, the upstream UP entity determines if it will perform the computing task as indicated (e.g. DPI operation), and it may compress the incoming QoS Flow packets. It may transfer some of the “Computing Service Data” towards the neighbor downstream UP entity for offloading the computing task. Likewise, the downstream UP entity determines whether to perform the computing task as indicate (e.g. DPI operation). It may compress the incoming QoS Flow packets as indicated, and receive some of the “Computing Service Data” from the neighbor upstream UP entity. Upon configuration by the first CP entity, the upstream UP entity may establish the “DRB Type Tunnel” with the neighbor downstream UP entity as indicated. Afterwards, the upstream UP entity and downstream UP entity individually perform the computing task as indicated (e.g. DPI operation), and the “Computing Service Data” is transferred via the established “DRB Type Tunnel” and further processed by downstream UP entity.

In a third embodiment as in FIG. 7, the CU entity communicates via the E1AP signaling procedure. The tunnel type is DRB. For this example, the Service Type is an intelligence service. The UP Processing Mode is to locally backup packets, and the UP Forwarding Mode is DRB. This is merely one example of the parameters that can configured. The intelligent service used in this example may be associated with machine learning and/or artificial intelligence, including a training feature. The multiple UPs can offload tasks between one another. This is merely one example of the parameters that can be configured.

The CP entity is connecting with two neighbor basestation UP(s) via an E1 interface. The upstream UP entity and downstream UP entity are both capable of performing the intelligence service and backup tasks (e.g. executing particular AI Training operation with the incoming packets). Due to the AI training accuracy and reliability requirements, the CP entity may let the upstream UP entity and downstream UP entity perform the task jointly. For example, the upstream UP entity performs compressing operation towards incoming packets to collect the statistics about the packets' delay and jitter, then transmits the packets to downstream UP entity. The downstream UP entity performs a locally backup operation to save sample data for future AI training. The “Intelligence Service Data” needs to be transferred from the upstream UP entity to the downstream UP entity via proper type of forwarding tunnel.

As controlling node, the CP entity configures the upstream UP entity and downstream UP entity individually via E1AP signaling procedure. The following parameters are configured for the upstream UP entity in one example:
“Service Type”: Intelligence service with AI training,
“UP Processing Mode”: compressing incoming packets,
“UP Forwarding Mode”: DRB Type.

The following parameters are configured for the downstream UP entity in one example:
“Service Type”: Intelligence service with AI training,
“UP Processing Mode”: Locally backup incoming packets,
“UP Forwarding Mode”: DRB Type.

Upon configuration by the CP entity, the upstream UP entity determines whether to perform the intelligence task as indicated (e.g. AI training for vertical industry application). It may compress the incoming packets as indicated, and transfer some of the sample data towards the neighbor downstream UP entity for “Intelligence Service Data.” Likewise, the downstream UP entity determines whether to perform the backup task as indicated (e.g. AI training for vertical industry application), and it shall backup the incoming packets as indicated. It may receive some of the “Intelligence Service Data” from the neighbor upstream UP entity. Upon configuration by CP entity, the upstream UP entity shall establish the “DRB Type Tunnel” with the neighbor downstream UP entity as indicated. Afterwards, the upstream UP entity and downstream UP entity individually performs the Intelligence AI training and the backup task as indicated (e.g. for vertical industry application), and the “Intelligence Service Data” is transferred via the established “DRB Type Tunnel” and further processed by the downstream UP entity.

In a fourth embodiment, there may be multiple CU entities as in FIG. 8. This is different from embodiment 3 because of the multiple CU entities. The tunnel type and the forwarding mode is DRB. The CU entities communicate via an Xn interface. For this example, the Service Type is intelligence service. The UP Processing Mode is different for the two UP entities, being locally backup packets for the downstream UP entity and compressing incoming packets for the upstream UP entity. This is merely one example of the parameters that can configured.

As shown in FIG. 8, two CP entities are connected with each other via standardized Xn interface. A first CP entity is connecting with the upstream UP entity, and a second CP entity is connecting with the downstream UP entity via standardized E1 interface. The upstream UP entity and downstream UP entity are both capable of performing the intelligence service or AI training and the backup task (e.g. executing AI Training with the incoming packets). Due to the AI Training accuracy and reliability requirements, the CP entity determines whether to let the upstream UP entity and downstream UP entity perform the task jointly. In this example, the upstream UP entity performs compressing operation towards incoming packets to collect the statistics about the packets' delay and jitter, then transmits the packets to downstream UP entity and performs the local backup operation to save sample data for future training. The “Intelligence Service Data” may be transferred from the upstream UP entity to the downstream UP entity via proper type of forwarding tunnel.

As controlling node, the first CP entity may configure the upstream UP entity via E1AP signaling procedure. This may include the following parameters in one example:
“Service Type”: Intelligence service, AI training for vertical industry application,
“UP Processing Mode”: compressing incoming packets,
“UP Forwarding Mode”: DRB Type.

The first CP entity transmits the configuration parameters to the second CP entity via Xn signaling procedure, then the second CP entity configures the downstream UP entity via E1AP signaling procedure, which includes the following parameters in one example:
“Service Type”: Intelligence service, AI training for vertical industry application,
“UP Processing Mode”: locally backup incoming packets,
“UP Forwarding Mode”: DRB Type.

Upon configuration by the first CP entity, the upstream UP entity gets to know that it shall perform the intelligence AI training task as indicated (e.g. AI training for vertical industry application), and it may compress the incoming packets as indicated, and transfer some of the sample data towards the neighbor downstream UP entity for “Intelligence Service Data.” Likewise, the downstream UP entity determines whether to perform the backup task as indicated (e.g. AI training for vertical industry application), and it may backup the incoming packets as indicated. It may receive some of the “Intelligence Service Data” from the neighbor upstream UP entity. Upon configuration by the first CP entity, the upstream UP entity shall establish the “DRB Type Tunnel” with the neighbor downstream UP entity as indicated. Afterwards, the upstream UP entity and downstream UP entity individually perform the intelligence AI training and backup task as indicated (e.g. AI training for vertical industry application), and the “Intelligence Service Data” is transferred via the established “DRB Type Tunnel” and further processed by the downstream UP entity.

In a fifth embodiment as in FIG. 7, the CU entity communicates via the E1AP signaling procedure. The UP forwarding mode and tunnel type is TCP and the Service Type is an intelligence service. In this example, the UP Processing Mode is to segment incoming packets. The segmenting of incoming packets may allow for different training. The intelligent service used in this example may be associated with machine learning and/or artificial intelligence, including a training feature. This is merely one example of the parameters that can be configured.

The CP entity is connecting with two neighbor UP entities through an E1 interface. The upstream UP entity and downstream UP entity are both capable of performing the intelligence service or AI training task (e.g. executing particular segmenting operation towards the incoming packets for XR services). Due to the computing power limitation and user experience requirements, the CP entity determines whether to let the upstream UP entity and downstream UP entity perform the intelligence AI training task jointly (e.g. upstream UP entity can split the video and voice related data and perform the segmenting operation towards video related packets for the AI codec training. The downstream UP entity performs the segmenting operation towards voice related packets for AI codec training. The “Intelligence Service Data” may be transferred from upstream UP entity to downstream UP entity via proper type of forwarding tunnel.

As controlling node, the CP entity configures the upstream UP entity and downstream UP entity individually via the E1AP signaling procedure, which includes the following parameters in one example:
“Service Type”: Intelligence service, AI codec training for XR application,
“UP Processing Mode”: segmenting incoming packets,
“UP Forwarding Mode”: TCP Type.

Upon configuration by the CP entity, the upstream UP entity determines whether to perform the intelligence AI training task as indicated (e.g. AI codec training for XR application). It may segment the incoming packets as indicated, and transfer some of the “Intelligence Service Data” towards the neighbor downstream UP entity for offloading the AI training task. Likewise, the downstream UP entity determines whether to perform the intelligence AI training task as indicated (e.g. AI codec training for XR application). It can segment the incoming packets as indicated, and receive some of the “Intelligence Service Data” from the neighbor upstream UP entity. Upon configuration by the CP entity, the upstream UP entity shall establish the “TCP Type Tunnel” with the neighbor downstream UP entity. Afterwards, the upstream UP entity and downstream UP entity individually perform the intelligence AI training task as indicated (e.g. AI codec training for XR application), and the “Intelligence Service Data” is transferred via the established “TCP Type Tunnel” and further processed by the downstream UP entity.

In a sixth embodiment, there may be multiple CU entities as in FIG. 8. This is different from embodiment 5 because of the multiple CU entities. The tunnel type and the forwarding mode is TCP. The CU entities communicate via an Xn interface. For this example, the Service Type is intelligence service. The UP Processing Mode is segmenting incoming packets. This is merely one example of the parameters that can configured.

The first CP entity is connecting with the upstream UP entity, and the second CP entity is connecting with the downstream UP entity via standardized E1 interface. The upstream UP entity and downstream UP entity are both capable of performing the intelligence AI training task (e.g. AI codec training for XR services). Due to the computing power limitation and user experience requirement, the CP entity determines whether to let the upstream UP entity and downstream UP entity perform the intelligence AI training task jointly. For example, the upstream UP entity will split the video and voice related data, and performs segmenting operation towards video related packets for AI codec training, while the downstream UP entity performs segmenting operation towards voice related packets for AI codec training. The “Intelligence Service Data” needs to be transferred from the upstream UP entity to the downstream UP entity via proper type of forwarding tunnel.

As controlling node, the first CP entity configures the upstream UP entity via E1AP signaling procedure, which includes the following parameters in one example:
“Service Type”: Intelligence service, intelligence AI training for XR application,
“UP Processing Mode”: segmenting incoming packets,
“UP Forwarding Mode”: TCP Type.

The first CP entity transmits the configuration parameters to the second CP entity via Xn signaling procedure. The second CP entity configures the downstream UP entity via E1AP signaling procedure, which includes the following parameters in one example:
“Service Type”: Intelligence service, intelligence AI training for XR application,
“UP Processing Mode”: segmenting incoming packets,
“UP Forwarding Mode”: TCP Type.

Upon configuration by the first CP entity, the upstream UP entity determines whether to perform the intelligence service or AI training task as indicated (e.g. AI training for XR application), and it may segment the incoming packets as indicated, and transfer some of the “Intelligence Service Data” towards the neighbor downstream UP entity for offloading the intelligence AI training task. Likewise, the downstream UP entity determines whether to perform the intelligence AI training task as indicated (e.g. AI training for XR application), and it shall segment the incoming packets, and it receives some of the “Intelligence Service Data” from the neighbor upstream UP entity. Upon configuration by the first CP entity, the upstream UP entity establishes the “TCP Type Tunnel” with the neighbor downstream UP entity. Afterwards, the upstream UP entity and the downstream UP entity individually perform the intelligence AI training task (e.g. AI training for XR application), and the “Intelligence Service Data” is transferred via the established “TCP Type Tunnel” and further processed by the downstream UP entity.

In a seventh embodiment as in FIG. 7, the CU entity communicates via the E1AP signaling procedure. The UP forwarding mode and tunnel type is QUICP in this example. The Service Type is an intelligence service, but with federated learning execution. The UP Processing Mode is concatenating incoming packets. The intelligent service used in this example may be associated with machine learning and/or artificial intelligence, including a training feature. This is merely one example of the parameters that can be configured.

The upstream UP entity and downstream UP entity are both capable of performing the intelligence service or AI training task, such as executing federated learning. Due to the sample data privacy requirements, the CP entity determines whether to let the upstream UP entity and downstream UP entity perform the intelligence AI training task jointly. The upstream UP entity and downstream UP entity may not transmit the sample data to each other for data privacy protection, so they use their own local sample data to obtain gradient information and then combine them together by one node. Accordingly, the “Intelligence Service Data” needs to be bidirectional to be transferred between the upstream UP entity and downstream UP entity via proper type of forwarding tunnel.

As controlling node, the CP entity configures the upstream UP entity and downstream UP entity individually via E1AP signaling procedure, which includes the following parameters in one example:
“Service Type”: Intelligence service, federated learning application,
“UP Processing Mode”: concatenating incoming packets,
“UP Forwarding Mode”: QUIC Type.

Upon configuration by the CP entity, the upstream UP entity determines whether to perform the intelligence service or AI training task. In this example, the service/task includes a federated learning application. It may concatenate the incoming packets and transfer/receive the gradient information as the “Intelligence Service Data” towards or from the neighbor downstream UP entity. Likewise, the downstream UP entity determines whether to perform the intelligence AI training task (e.g. federated learning application). It may concatenate the incoming packets and transfer or receive the gradient information as “Intelligence Service Data” towards or from the neighbor upstream UP entity. Upon configuration by the CP entity, the upstream UP entity establishes the “QUIC Type Tunnel” with the neighbor downstream UP entity. Afterwards, the upstream UP entity and downstream UP entity individually perform the intelligence AI training task (e.g. federated learning application), and gradient information as “Intelligence Service Data” is transferred via the established “QUIC Type Tunnel” and further processed by upstream UP entity or downstream UP entity.

The following is a list of abbreviations:

TABLE 1
Abbreviations.

| Abbreviation | Term |
|---|---|
| 5G | Fifth Generation |
| 5QI | 5G QoS Identifier |
| QoS | Quality of Service |
| LTE | Long Term Evolution |
| EPC | Evolved Packet Core |
| NR | New Radio |
| RNL | Radio Network Layer |
| TNL | Transport Network Layer |
| GTP-U | GPRS Tunnel Protocol |
| SCTP | Streaming Control Transport Protocol |
| AMF | Access Mobility Function |
| SMF | Session Management Function |
| UPF | User Plane Function |
| CU | Centralized Unit |
| DU | Distributed Unit |
| RU | Radio Unit |
| CP | Control Plane |
| UP | User Plane |
| BSR | Buffer Status Report |
| PHR | Power Headroom Report |
| PDCP | Packet Data Convergence Protocol |
| SDAP | Service Data Adaptation Protocol |
| RLC | Radio Link Control |
| MAC | Medium Access Control |
| SRB | Signaling Radio Bearer |
| DRB | Data Radio Bearer |
| GBR | Guaranteed Bit Rate |
| AMBR | Aggregated Maximum Bit Rate |
| RB | Radio Bearer |
| LCH | Logical Channel |
| LCP | Logical Channel Prioritized |
| DRX | Discontinuous Reception |
| HARQ | Hybrid ARQ |
| DCI | Downlink Control Information |
| eMBB | enhanced Mobile Broadband |
| mMTC | massive Machine Type Communications |
| URLLC | Ultra-Reliable and Low Latency |
| | Communications |
| OAM | Operation Administration and |
| | Maintenance |
| MN | Master node |
| SN | Secondary node |
| MCG | Master Cell Group |
| SCG | Secondary Cell Group |
| RRC | Radio Resource Control |
| RRM | Radio Resource Management |
| Uu-C | Uu- Control Plane |
| Uu-U | Uu- User Plane |
| NG-C | Next Generation- Control Plane |
| NG-U | Next Generation- User Plane |
| Xn-C | Xn- Control Plane |
| Xn-U | Xn - User Plane |
| RNA | RAN Notification Area |
| NTN | Non Terrestrial Network |
| MR-DC | Multi-RAT Dual Connectivity |
| EN-DC | E-UTRA-NR Dual Connectivity |
| NR-DC | Intra-NR Dual Connectivity |
| NGEN-DC | NG E-UTRA-NR Dual Connectivity |
| NE-DC | NR-E-UTRA Dual Connectivity |
| CHO | Conditional Handover |
| DNN | Deep Neutral Network |
| MEC | Mobile Edge Computing |
| RLM | Radio Link Monitor |
| BFR | Beam Failure Recovery |
| MBS | Multicast Broadcast Service |
| SIB | System Information Block |
| QUIC | Quick UDP Internet Connection |
| UDP | User Datagram Protocol |
| TCP | Transmission Control Protocol |
| DPI | Deep Packet Inspecting |

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication comprising:
determining user plane (UP) configurations for at least one UP network entity for performing user plane (UP) functions at the at least on first UP network entity; and
transmitting the UP configurations to the at least one UP network entity for performing the UP functions,
wherein the UP functions comprise at least one function other than or in addition to data package forwarding.

2. The method of claim 1, wherein each of the UP configurations indicates a data service type and/or a UP function mode including one of a UP processing mode or a UP data forwarding mode.

3. The method of claim 2, wherein the UP functions support services other than or in addition to a communication service, including at least one of a computing, intelligence, storage, or security service.

4-6. (canceled)

7. The method of claim 1, wherein the at least one UP network entity comprises two or more UP network entities that are configured to collaborate in performing the UP functions.

8. (canceled)

9. The method of claim 2, wherein each of the UP configurations indicates the data service type, the UP processing mode, or the UP data forwarding mode using an index identification or an explicit predefined indicator.

10. The method of claim 1, wherein at least one of the UP configurations is provided for allowing a data transfer service to terminate at an intermediate node rather than an end node.

11. The method of claim 10, wherein the intermediate node is configured to forward user data of different data service types to any other network node.

12. The method of claim 2, wherein the UP processing mode indicates one or more of:
transparently delivering incoming packets;
compressing incoming packet;
concatenating incoming packets;
segmenting incoming packets; or
locally backing up incoming packets.

13. The method of claim 2, wherein the UP data forwarding mode is associated with one or more of:
a protocol data unit (PDU) session type;
a data radio bearer (DRB) type;
a CP signaling type;
a transmission control protocol (TCP) type; or
a quick user datagram protocol Internet connection (QUIC) type.

14. A method performed by a user plane (UP) network entity, comprising:
receiving at least one UP configuration from a control plane (CP) network entity for supporting different types of data services; and
performing UP functions based on the at least one UP configuration,
wherein the UP functions comprise at least one function other than or in addition to data package forwarding.

15. The method of claim 14, wherein data services supported comprise one or more of communication services, computing services, intelligence services, storage services, or security services.

16-17. (canceled)

18. The method of claim 14, wherein the receiving is through internal signaling or communication interface based signaling.

19. The method of claim 14, wherein each of the at least one UP configuration indicates a data service type and/or a UP function mode including one of a UP processing mode or a UP data forwarding mode.

20. The method of claim 19, wherein each of the at least one UP configuration indicates the data service type, the UP processing mode, or the UP data forwarding mode using an index identification or an explicit predefined indicator.

21. The method of claim 14, wherein the at least one UP configuration allows for a data transfer service to terminate at an intermediate node rather than an end node.

22. The method of claim 21, wherein the intermediate node is configured to forward user data of different data service types to any other network node.

23. The method of claim 19, wherein the UP processing mode indicates one or more of:
transparently delivering incoming packet;
compressing incoming packet;
concatenating incoming packets;
segmenting incoming packets; or
locally backing up incoming packets.

24. The method of claim 19, wherein the UP data forwarding modes at least comprise:
a protocol data unit (PDU) session type;
a data radio bearer (DRB) type;
a CP signaling type;
a transmission control protocol (TCP) type; or
a quick user datagram protocol Internet connection (QUIC) type.

25. The method of claim 14, wherein when multiple types of data services are configured simultaneously for the UP network entity, multiple and different sets of UP configurations are applied simultaneously.

26. A wireless communications apparatus comprising at least one processor and a memory, wherein the at least one processor is configured to read code from the memory to:
determine, user plane (UP) configurations for at least one UP network entity for performing user plane (UP) functions at the at least on first UP network entity; and
transmit the UP configurations to the at least one UP network entity for performing the UP functions,
wherein the UP functions comprise at least one function other than or in addition to data package forwarding.

27. (canceled)
